(19) United States
(12) Patent Application Publication
(10) Pub. No.: US 2009/0135264 A1
(43) Pub. Date: May 28, 2009

(54) MOTION BLUR DETECTION USING METADATA FIELDS

(75) Inventor: George C. John, Arlington Heights, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/946,097

(22) Filed: Nov. 28, 2007

(51) Int. Cl. H04N 5/225; H04N 5/76

(52) U.S. Cl. 348/220.1; 348/231.99; 348/E09.002

(57) ABSTRACT

A wireless communication device for motion blur detection comprising a transceiver, an optical sensor, a motion sensor, a processor and a memory. The transceiver provides wireless communication with a remote device. The optical sensor captures an image, and the motion sensor generates motion information associated with the image captured by the optical sensor. The processor controls the wireless communication by the transceiver and, further, controls the identification and storage of the motion information associated with the image. The memory portion stores the image and the associated motion information. Upon storing, the device may transmit the image and the associate motion information to the remote device via a wireless communication link, whereby the image is processed based on the associated motion information.

### FIELD OF THE INVENTION

The present invention relates generally to the field of managing image quality on a mobile communication device equipped with a camera. In particular, the present invention relates to systems and methods for correcting motion blur images captured by a camera of a mobile communication device.

### BACKGROUND OF THE INVENTION

Many mobile communication devices are equipped with camera components and, thus, are often referred to as camera phones. Although some devices provide camera resolution that approach the resolution of digital cameras, the quality of images captured by their camera components still fall short. Some of the camera components of the mobile communication device, such as the hardware, software and controls, are not as robust as those of digital cameras. For example, camera phones have a next shot delay that is typically slower than stand-alone digital cameras. Also, camera phones often require onscreen prompts to save a photo after every shot. Most camera phones further a flash range that is a faction of most stand-alone digital cameras. What is needed is a camera phone standard for the photo industry to narrow the gap. The camera phone standard should provide guidelines for measuring photo quality and mandating disclosure of the types of sensors, lenses, and other camera elements of camera phones.

Electronic image stabilization for correction of motion blur has been of significant interest in camera phones, due to the low capture speeds of camera phones and behavior of their users. Typically, electronic image stabilization is accomplished by estimating camera motion when capturing photos and subsequently compensating for motion blur using signal processing techniques, or installing mechanical parts that can compensate for camera motion. Both methods are expensive and require more resources than typically available in a camera phone.

### BRIEF DESCRIPTION OF THE DRAWINGS

FIG. 1 is a block diagram illustrating an example of components of a camera phone in accordance with the present invention.

FIG. 2 is a data format illustrating an example of metadata in accordance with the present invention that may be communicated by a camera phone, such as the camera phone of FIG. 1.

FIG. 3 is a flow diagram illustrating an example of steps for obtaining metadata, along with an associated image, that may be performed by a camera phone, such as the camera phone of FIG. 1.

FIG. 4 is a flow diagram illustrating an example of steps for processing the image based on the associated metadata collected in FIG. 3.

### DETAILED DESCRIPTION OF THE EMBODIMENTS

An optical sensor of a wireless communication device is subject to movement during capture, and this movement may be measured by several approaches, including motion detection using an accelerometer, a gyroscope or a second camera as a motion sensor. The movement detected during capture is then stored in metadata associated with the image, such as a still image. The store information may be used later in post processing to correct for motion blur. In this manner, image stabilization may address correction of blurred subject matter without requiring extensive processing in the wireless communication device or blind deconvolution after capture. The motion blur is measured during capture, and the value stored in the metadata. This information is used to correct for motion blur in post processing during subsequent printing, displaying or transmission.

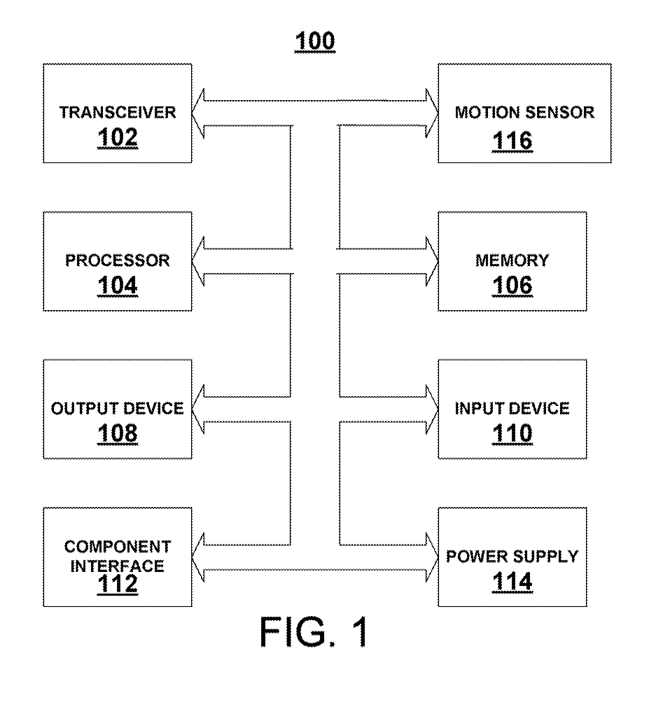

Referring to FIG. 1, there is provided a block diagram illustrating an example of internal components 100 of a wireless communication device in accordance with the present invention. The example embodiment includes one or more wired or wireless transceivers 102, one or more processors 104, a memory portion 106, one or more output devices 108, and one or more input devices 110. Each embodiment may include a user interface that comprises the output device(s) 108 and the input device(s) 110. Each transceiver 102 may be directly wired to another component or utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE or IEEE 802.16) and their variants; a peer-to-peer or ad hoc communications such as HomeRF, Bluetooth and IEEE 802.11 (a, b, g or n); and other forms of wireless communication such as infrared technology. Each transceiver 102 may be a receiver, a transmitter or both. For example, for one embodiment of the wireless communication device, a transmitter may be a receiver, or include a receiver portion, that is configured to receive presence data from a remote device.

The internal components 100 may also include a component interface 112 to provide a direct connection to auxiliary components or accessories for additional or enhanced functionality. Auxiliary components or accessories that may communicate with the transceiver 102 and/or component interface 112 include one or more sensors for detecting light, sound, odor, motion, connectivity and power to produce the remote and local state data. The internal components 100 preferably include a power source 114, such as a power supply or portable battery, for providing power to the other internal components.

The input and output devices 108, 110 of the internal components 100 may include a variety of visual, audio and/or mechanical outputs. For example, the output device(s) 108 may include a visual output device such as a liquid crystal display, plasma display, incandescent light, fluorescent light, and light emitting diode indicator. Other examples of output devices 108 include an audio output device such as a speaker, alarm and/or buzzer, and/or a mechanical output device such as a vibrating, motion-based mechanism. Likewise, by example, the input devices 110 may include a visual input device such as an optical sensor (for example, a camera), an audio input device such as a microphone, and a mechanical input device such as button or key selection sensors, touch pad sensor, touch screen sensor, capacitive sensor, and switch.

For the present invention, the internal components include a motion sensor 116 that may be included in, or in addition to, the input devices 110. Also, the input devices 110 include an optical sensor, such as a camera, which may be integrated with, or distinct from, the motion sensor 116. The motion sensor 116 generates raw data corresponding to device motion in response to detecting movement by one or more components of the wireless communication device, including the optical sensor. For one embodiment, the motion sensor 116 may be an accelerometer or gyroscope. For another embodiment, the motion sensor 116 may be a second optical sensor, used in conjunction with a first optical sensor for capturing images, such as still images or motion video. For yet another embodiment, the motion sensor 116 may be the same optical sensor that is used to capture the associated image. Other ways for detecting motion include, but are not limited to, positioning systems that may detect the location of the wireless communication device, such as a Global Positioning System or triangulation-based positioning system.

The memory portion 106 of the internal components 100 may be used by the processor 104 to store and retrieve data. The data that may be stored by the memory portion 106 include, but is not limited to, operating systems, applications, and data. Each operating system includes executable code that controls basic functions of the wireless communication device, such as interaction among the components of the internal components 100, communication with external devices via each transceiver 102 and/or the component interface 112, and storage and retrieval of applications and data to and from the memory portion 106. Each application includes executable code utilizes an operating system to provide more specific functionality for the wireless communication device. Data is non-executable code or information that may be referenced and/or manipulated by an operating system or application for performing functions of the wireless communication device.

It is to be understood that FIG. 1 is for illustrative purposes only and is for illustrating components of a wireless communication device in accordance with the present invention, and is not intended to be a complete schematic diagram of the various components required for a wireless communication device. Therefore, a wireless communication device may include various other components not shown in FIG. 1, or may include a combination of two or more components or a division of a particular component into two or more separate components, and still be within the scope of the present invention.

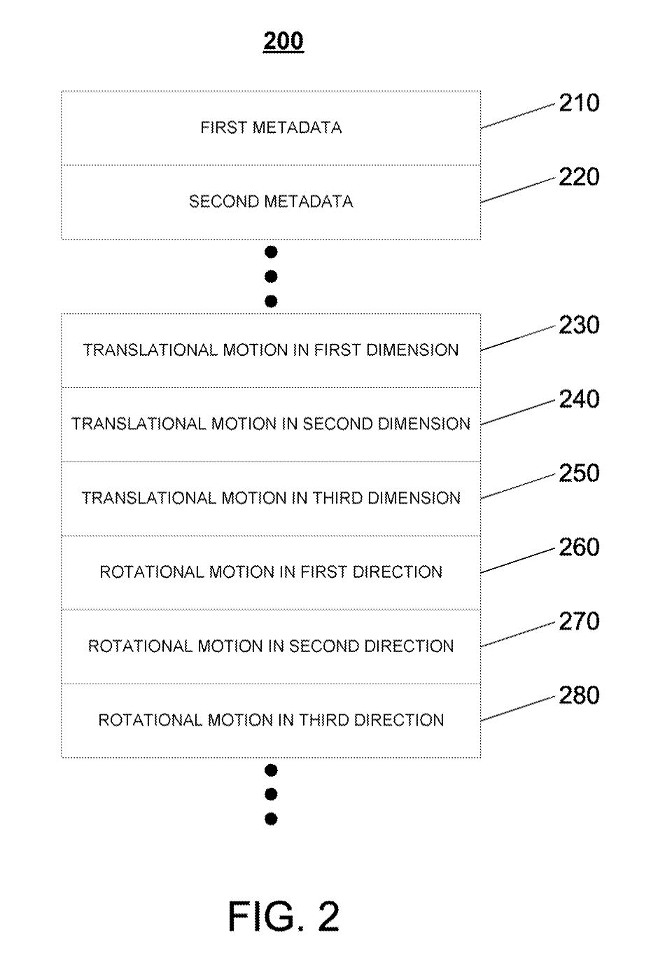

Referring to FIG. 2, there is shown a data format illustrating an example of metadata in accordance with the present invention. The metadata may be store in the memory portion 106 and communicated via the transceiver 102 of the internal components 100 of the wireless communication device. In general, metadata fields 200 associated with an image provides basic information for identifying and interpreting the image. In addition, the metadata fields 200 may also include information for enhancing the image for subsequent processing. Thus, as shown in FIG. 2, the metadata fields 200 includes a plurality of fields for the above purposes, such as first metadata 210 and second metadata 220.

For the present invention, the metadata fields 200 may include translational motion information, rotational motion information, or both types of information. For translational motion information, the translational motion may be expressed in single or multiple dimensions. For one embodiment, the translational motion information may include a first dimension 230, a second dimension 240 and a third dimension 250, as shown in FIG. 2. For example, the first, second and third dimensions of the translational motion information may correspond to linear moments in x, y and z dimensions of a three-dimensional axis. For rotational motion information, the rotational motion may be expressed in single or multiple directions. For one embodiment, the rotational motion may include a first direction 260, a second direction 270, and a third direction 280 about axes of a third-dimensional axis. For example, the first, second and third directions of the rotational motion may correspond to the rotational motion for pitch (motion about a lateral or transverse axis), yaw (motion about a vertical axis) and roll or tilt (motion about a longitudinal axis).

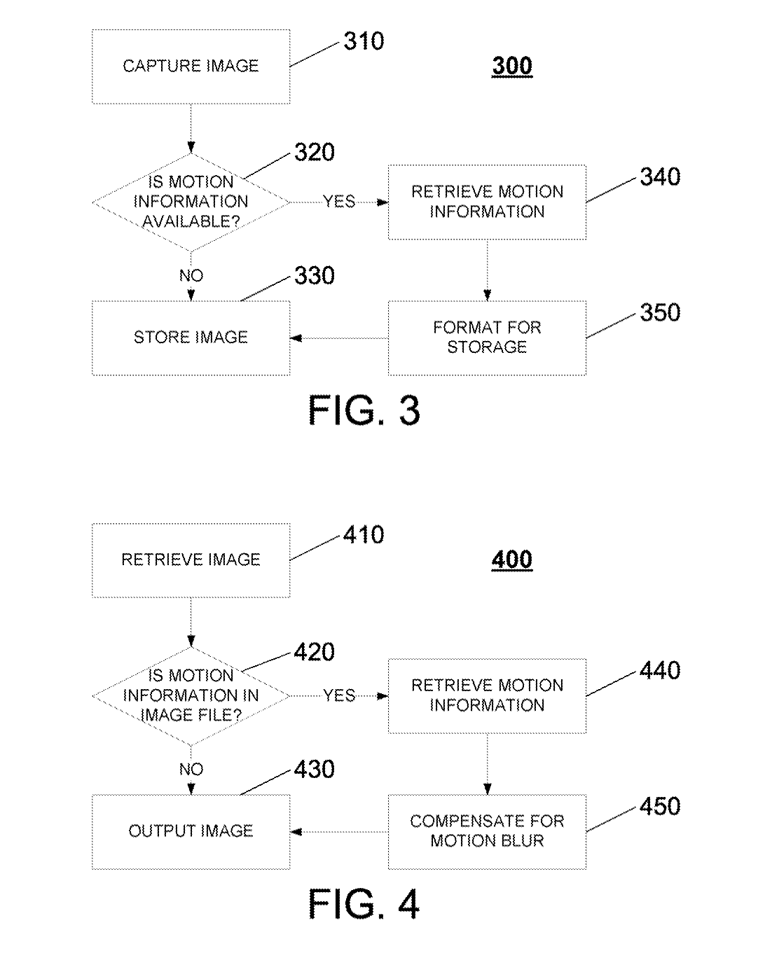

Referring to FIG. 3, there is shown a flow diagram illustrating an example of steps for obtaining metadata 300, along with an associated image, that may be performed by the internal components 100 of a wireless communication device for motion blur correction. The wireless communication device captures an image using an optical sensor 110 of the wireless communication device at step 310. The wireless communication device may capture the image in response to detecting an activation at an input device 110, such as a user interface of the input device. Next, the wireless communication device determines whether motion information is available for the captured image at step 320. For example, the processor 104 may seek motion information from the input device 110 that captured the image or from a motion sensor 116 associated with the input device. Thus, the input device 110 or motion sensor 116 associated with the input device generates the motion information. Similar to capturing the image, the wireless communication device may generate the motion information in response to detecting an activation at an input device 110, such as a user interface of the input device. If motion information is not available, then the image is stored in the memory portion 106 without any motion information associated with it.

On the other hand, if motion information is available, then the wireless communication device may then retrieve the motion information from the input device 110 or motion sensor 116 associated with the input device at step 340. The wireless communication device may then format the motion information in preparation for storage in the memory portion 106 at step 350. For example, the processor 104 may incorporate the motion information into a metadata field or metadata fields associated with the image before storing the metadata in the memory portion. Thereafter, the wireless communication device may store the motion information in the memory portion 106 of the wireless communication device at step 330. For one embodiment, the stored image and associated motion information may be transmitted to a remote device via a wireless communication link, whereby the image is processed based on the associated motion information. The image and the associated motion information may be transmitted while the device is communicating wirelessly or not otherwise communicating wirelessly.

Referring to FIG. 4, there is shown a flow diagram illustrating an example of steps for processing the image based on the associated metadata 400, which may be performed by a remote device that receives or otherwise has access to the image and metadata. In order to minimize processing burdens on the wireless communication device, the steps illustrated by FIG. 4 are performed by a remote device rather than the wireless communication device itself. The remote device retrieves the image at step 410 by either accessing the memory portion 106 of the wireless communication device via a transceiver 102 or receiving the image from the same. The remote device then determines whether motion information, in the form of metadata fields or the like, is available at step 420. For example, the remote device may access the memory portion 106 of the wireless communication device, receive the motion information from the transceiver 102 of the wireless communication device, or extract the motion information from the image file which includes the image. If the motion information is not available or otherwise not accessible, then the remote device may output the image “as is”, i.e., without motion blur correction in accordance with the present invention, at an output device 108 of the wireless communication device, remote device or both at step 430. If, on the other hand, the motion information is available, then the remote device retrieves the motion information at step 440. Similar to previous steps, the remote device may access the memory portion 106 of the wireless communication device, receive the motion information from the transceiver 102 of the wireless communication device, or extract the motion information from the image file which includes the image. Next, the remote device may correct or otherwise compensate for motion blur based on the motion information at step 450. For example, the remote device may perform an inverse point spread function, or deconvolution technique, for improving the image quality by compensating for motion blur. Thereafter, the remote device may output the image, as corrected for motion blur in accordance with the present invention at an output device 108 of the wireless communication device, remote device or both at step 430.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless communication device with motion blur detection comprising:
a transceiver configured to provide wireless communication with a remote device;
an optical sensor configured to capture an image;
a motion sensor configured to generate motion information associated with the image captured by the optical sensor;
a processor configured to control the wireless communication by the transceiver, the processor being further configured to control the identification and storage of the motion information associated with the image; and
a memory portion configured to store the image and the associated motion information.

2. The wireless communication device of claim 1, wherein the processor incorporates the motion information into metadata associated with the image and stores the metadata in the memory portion.

3. The wireless communication device of claim 1, wherein the optical sensor is configured to capture still image or motion video.

4. The wireless communication device of claim 1, wherein the motion sensor is an accelerometer, a gyroscope, or a second optical sensor.

5. The wireless communication device of claim 1, wherein the transceiver transmits the image and the associated motion information to the remote device via a wireless communication link.

6. The wireless communication device of claim 1, wherein the motion information includes translational motion information.

7. The wireless communication device of claim 6, wherein the translational motion information includes translational motion in at least two dimensions.

8. The wireless communication device of claim 1, wherein the motion information includes rotational motion information.

9. The wireless communication device of claim 8, wherein the rotational motion information includes rotational motion in at least two directions.

10. A method of a wireless communication device for motion blur detection, the method comprising:
capturing an image using an optical sensor of the wireless communication device;
generating motion information using a motion sensor of the wireless communication device;
storing the motion information in a memory portion of the wireless communication device; and
transmitting the image and the associate motion information to a remote device via a wireless communication link, whereby the image is processed based on the associated motion information.

11. The method of claim 10, further comprising:
determining whether the motion information is available; and
retrieving the motion information upon determining that the motion information is available.

12. The method of claim 10, further comprising detecting activation at a user interface of the method, wherein capturing an image and generating motion information occurs in response to detecting the activation of the user interface.

13. The method of claim 10, further comprising incorporating the motion information into metadata associated with the image before storing the metadata in the memory portion.

14. The method of claim 10, wherein transmitting the image and the associated motion information to a remote device via a wireless communication link includes transmitting the image and associated motion information while the device is not otherwise communicating wirelessly.

15. The method of claim 10, wherein transmitting the image and the associated motion information to a remote device via a wireless communication link includes transmitting the image and associated motion information while the device otherwise communicating wirelessly.

16. The method of claim 10, wherein the motion information includes translational motion information.

17. The method of claim 16, wherein the translational motion information includes translational motion in at least two dimensions.

18. The method of claim 10, wherein the motion information includes rotational motion information.

19. The method of claim 18, wherein the rotational motion information includes rotational motion in at least two directions.
